(19) United States
(12) Patent Application Publication
(10) Pub. No.: US 2003/0210262 A1
(43) Pub. Date: Nov. 13, 2003

(54) Video microscopy system and multi-view virtual slide viewer capable of simultaneously acquiring and displaying various digital views of an area of interest located on a microscopic slide

(75) Inventors: Thomas Gahm, Elon, NC (US); Rainer Dorrer, Mullheim-Vogisheim (DE); Joachim Schmid, Chapel Hill, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: TriPath Imaging, Inc.

(21) Appl. No.: 10/143,735

(22) Filed: May 10, 2002

(51) Int. Cl. G09G 5/00

(52) U.S. Cl. 345/732

(57) ABSTRACT

The present invention provides a slide viewer capable of simultaneous display of more than one scan of an area of interest of a slide. The slide viewer includes a database containing at least two data files representing different scans for a same area of interest on one or multiple correlated slides or at least two different digital presentations of the same scan. The scans are views of different illumination and/or of different contrast. Associated with the database are a processor and a display. The processor retrieves data files representing different scans of the same of area of interest and displays them on the display. The present invention allows a user to simultaneously view scans of the same area of interest, where the scans are of views different from each other by either illumination and/or contrast or by the digital information content presented, and/or by the information acquired from multiple correlated slides.

### FIELD OF THE INVENTION

The present invention relates generally to the acquisition and analysis of digital images of objects and areas of interest located on a microscopic slide, and more particularly to a system and method capable of providing various digital views of the same areas of interest to a user, where each view provides digital images with different information for use in quantitative and qualitative analysis of the objects on the microscopic slide.

### BACKGROUND OF THE INVENTION

Microscopic analysis is a widely used research tool in the field of cellular biology and pathology. Specifically, tissue samples and cell preparations are visually inspected by pathologists under several different conditions and test procedures with use of microscopes. Based on these visual inspections, determinations concerning the tissue or cellular material can be deduced. For example, in the area of cancer detection and research, microscopic analysis aids in the detection and quantification of genetic materials that appear related to the cause and progression of cancer, such as genes or messenger RNA, or the expression of this genetic information in the form of proteins such as, for example, through gene amplification, gene deletion, gene mutation, messenger RNA molecule quantification, or protein expression analyses. Although numerous other laboratory techniques exist, microscopy is routinely used because it is an informative technique, allowing rapid investigations at the cellular and sub-cellular levels, while capable of being expeditiously implemented at a relatively low cost.

Although a desired research tool, conventional microscopic analysis does have some drawbacks. Specifically, microscopic analysis of tissue samples is typically an iterative process. The pathologist or other user usually begins with a low-resolution magnification setting on the microscope in which they are able to see a larger area of the sample. From this low-resolution view, the user determines areas of the sample that require closer inspection. These areas are then typically further analyzed using higher magnification levels. In many instances, the user may wish to alternate between the various magnification levels to determine which magnification level provides a desired and informative view of the selected area of the tissue sample. In this instance, the user must make a mental note of the current view at one magnification and compare it to the views at the other magnifications to determine which provides the best level of detail and resolution. Further, after each area is inspected, the user must typically return to the low-resolution setting to collect his/her bearings in the sample and to look for a next area of the sample for inspection. This procedure may cause the user to become confused as to what areas have and have not been inspected in the sample.

A similar situation exists in the field of molecular cell biology. Here one of the major goals of cancer research is the discovery of new markers that relate to the early stages and the progression of cancer. As such, during the marker discovery process, the task consists of identifying the cancer areas in the tissue section based on the tissue morphology and quantitatively or qualitatively assessing the marker expression within these areas versus the expression in normal regions. For a more reliable assessment, the marker presentation is often separated from the morphology through the use of different illumination methods, such as, for example, bright field versus dark field illumination (for the radiometric ISH assay) or bright field versus fluorescence microscopy, or different contrast methods such as, for example, phase contrast, differential interference contrast, etc. This requires the user to constantly switch between different optical microscope settings and to compare and correlate the different types of information gleaned from that “multi-view” approach in his mind which, especially where details are concerned, is close to impossible.

All these methods also require that the user reside at the physical location of the sample and the microscope. As such, the sample must typically be shipped to the location of the pathologist or the evaluation expert for analysis.

In light of these problems, virtual slide viewing devices have been developed to aid in microscopic inspection. In general, these systems perform one or more scans of the tissue sample at one or more resolutions. The scans are stored electronically for later viewing by the user. Typically there are two (2) different approaches: The first method scans the tissue sample at low resolution. Based on this first scan regions or objects of interest are identified, relocated and scanned at higher resolution. The second approach scans the slide at high resolution right from the beginning and extrapolates lower resolution views through sub sampling of the high-resolution data. The scans are actually a series of scans of different parts of the tissue. These series of scans represent individual tiles of the overall tissue sample.

After the scans at one or various magnifications have been taken of the slide, these data files are provided to a pathologist or other user for viewing. Specifically, the files are stored on a computing system that can be accessed either locally or remotely via either an Intranet or the Internet connection. The advantage of these conventional virtual slide viewers over more conventional methods of inspection with a microscope is that these virtual slide viewers allow a user to view both a low-resolution “big picture” view of the slide, while also allowing the user to view magnified images of selected areas of the slide. Further, the files containing the scans of a slide can either be transmitted to or accessed by the user from a remote location.

FIG. 1 illustrates a typical monitor display of data from a conventional virtual slide viewer. Specifically, during analysis of a virtual slide, the conventional slide viewer displays a low-resolution view 12 of the slide on a display 10. The low-resolution view consists of a series of tiles 14 that each represents a scan of a portion of the slide. The tiles 14 are pieced together to provide a view of either all or most of the slide. Using a mouse or keyboard commands, the user selects an area of interest in the slide. A separate window 16 on the display provides the user with higher magnified images of the selected area. Further, the display includes a control window 18 typically indicating all or part of the information about the presentation mode, presentation options, the displayed virtual slide 12 and the magnified view 16.

While conventional virtual slide viewers, such as the one illustrated in FIG. 1, provide a user with both a low-resolution scan and higher-resolution scans simultaneously on a display, these virtual slide viewers are restricted to only the bright field view. With the introduction of new tumor markers there is much more to the analysis and interpretation of a biological slide than only viewing areas of interest at different magnification. Specifically, different combinations of tumor markers may be added to the slide. Some of these markers can only be clearly presented and interpreted by using different contrast or illumination methods during the image acquisition in addition to bright field. Well-known examples are dark field illumination and fluorescent microscopy. From both methods images are derived which can be highly complementary in their information contents to the display of morphology in the bright field image. This is where conventional virtual slide viewers fall short. They do not provide these additional digital views of a slide and deny the pathologist crucial diagnostic information.

In addition, for most microscopic tests, the biological samples must first undergo specific detection and revelation preparations based on the analysis to be performed on the slide. These preparations may involve the addition of markers and dyes to the tissue sample. In some instances, a first dye is added to the sample and observations are made of the slide. The sample is then removed, destained and then restained with another dye for a second observation. As such, several different observations of a sample with different preparations can be made during an analysis of a sample.

For example, the preparation of samples for detection may involve different types of preparation techniques that are suited to microscopic image analysis, such as, for example, hybridization-based and immunolabeling-based preparation techniques. Such detection techniques may be coupled with appropriate revelation techniques, such as, for example, fluorescence-based and absorbance color reaction-based techniques.

Colorimetric, Radiometric and Fluorescent In Situ Hybridization (CISH, RISH, FISH) are detection and revelation techniques used, for example, for detection and quantification in genetic information amplification and mutation analyses. CISH, RISH and FISH can be applied to histological or cytological samples. These techniques use specific complementary probes for recognizing corresponding precise sequences. Depending on the technique used, the specific probe may include a colorimetric (CISH), radiometric (RISH) or a fluorescent (FISH) marker, wherein the samples are then analyzed using a transmitted light microscope with bright filed or dark field illumination or a fluorescence microscope, respectively. The use of a calorimetric, radiometric or fluorescent marker depends on the goal of the user; each type of marker having corresponding advantages over the other in particular instances.

In protein expression analyses, immunohistochemistry (“IHC”) and immunocytochemistry (“ICC”) techniques, for example, may be used. IHC is the application of immunochemistry to tissue sections, whereas ICC is the application of immunochemistry to cultured cells or tissue imprints after they have undergone specific cytological preparations such as, for example, liquid-based preparations. Immunochemistry is a family of techniques based on the use of a specific antibody, wherein antibodies are used to specifically target molecules inside or on the surface of cells. The antibody typically contains a marker that will undergo a biochemical reaction, and thereby experience a change of color, upon encountering the targeted molecules. In some instances, signal amplification may be integrated into the particular protocol, wherein a secondary antibody, that includes the marker stain, follows the application of a primary specific antibody. In both hybridization and immunolabeling studies, chromagens of different colors are used to distinguish among the different markers.

As mentioned, conventional virtual slide scanner and viewer systems only provide different magnifications of the bright field view of a sample, they do not provide different scans of a sample in terms of use of different dye markers, or dark field and/or fluorescent scans. A major reason for this failing of the prior art is due to the difficulty in matching coordinate systems for various scans. Specifically, in the prior art virtual slide viewing systems, the various magnification scans are mostly derived from one high-resolution scan through sub-sampling of the collected data. As such, there is an inherent perfect correlation between the low-resolution views derived from the high-resolution scan and the presentation of the high-resolution data. However, as soon as different complementary information has to be collected for the display in the multi-view virtual slide viewer, methods and systems have to be conceived which are either able to switch between different contrasting and illumination methods during the image acquisition within each field of view, or between multiple complete scans of the same slide with or without removing the slide from the scan platform between the different runs, or even to run the slide on different scan platforms and correlate the resulting data for a coordinated multi-view presentation. For instances where a sample is analyzed using several different sample preparations, the slide must be routinely removed from the microscope to add additional markers or dyes or to remove markers or dyes. In this instance, because the slide will not be placed at the exact same position when reinstalled in the microscope, the coordinate system of the subsequent scan of the tissue sample will be somewhat offset from the coordinate system of scans occurring prior to removal of the slide. This, in turn, makes it difficult, if not impossible, to positionally correlate the various scans of the same area of interest.

### BRIEF SUMMARY OF THE INVENTION

In view of the deficiencies with many conventional virtual slide viewing systems, the present invention provides a multi-view virtual slide viewing system that provides a display capable of illustrating multiple viewing windows containing different scans of an area of interest. The views may be either different magnifications of a selected area or different scans of the slide taken under different conditions. For example, the slide viewing system of the present invention may display a scan of the slide taken in with bright field illumination in one window and a scan of the same view with dark field illumination in another window of the display. This, in turn, not only allows the user to compare scans of varying magnification, but also to compare scans of the same slide taken under different illumination and optical conditions and with different markers, dyes, and other preparations and even scans taken from the same slide on different scan platforms. For example the slide viewer of the present invention is able to display a unitary low-resolution scan of the slide taken with a cost efficient flat bed scanner, as opposed to a display formed of tiles, and combine it in a correlated way with the image presentation of a tiled high resolution scan of the same slide taken with another scan platform. As such, the low-resolution display does not require processing to blend tiles together nor does it experience problems with resolution at tile boundaries. An additional advantage consists in the ability to add the high resolution scan at a later time and only on demand. In that respect a flat bed scanner can be used as a cost efficient pre scan device.

Besides displaying complementary views of a slide which are acquired either on different scan platforms or with different microscope settings the multi-view virtual slide viewer can also present additional views of a slide derived from an original scan via image analysis, such as displaying certain features via false color presentation and look up tables or images derived from chromagen separation. The chromagen separation is able to digitally separate the different chromagens such as markers labeled with certain stains, the counter stain, etc. and present them individually in separate images. Chromagen separation is described in patent applications filed by the Assignee of the present application. These patent applications are 1) U.S. patent application Ser. No. 09/957,446, filed Sep. 19, 2001, and entitled: Method For Quantitative Video-Microscopy and Associated System and Computer Software Program Product, and 2) U.S. patent application Ser. No. TBD, filed Jan. 24, 2002, and entitled: Method for Quantitative Video-Microscopy and Associated System and Computer Software Program Product. Both of the references are incorporated herein by reference.

The multi-view virtual slide viewer of the present invention is intended for display of scans of an area of interest at different magnifications and different focal planes. It is also contemplated for display of scans taken with different sample preparations, scan platforms, or microscope settings such as the following list which only names a few examples:

1) bright field-dark field scans of the same slide

2) multiple wavelength scans of the same slide

3) chromagenic separation of the same object

4) multiple restained slides

5) consecutive sections of the same tissue block or TMA block

6) multiple thinlayer slides with statistically equivalent cell distributions from the same sample of the same patient

7) bright field and FISH scans

8) tissue micro arrays (TMA)

9) bright field and fluorescent microscope scans

10) local feature distributions presented via false colors/look up tables overlaid or within the microscopic images.

For example, in one embodiment, the present invention provides a virtual slide viewing system connected to a database stored in a storage device. The database includes at least one set of data related to a particular tissue or cytology sample. The data set includes a low-resolution scan of either all or a substantial portion of the slide. This scan can be acquired using a flat bed scanner or similar device capable of scanning the entire slide. It also can be derived from subsampling the data of the high resolution scan. In addition, the data set can include various scans of the tissue sample taken under different conditions and/or sample preparations. Specifically, the database may include scans taken at different levels of resolution of different areas of the sample. It may also include scans taken with different microscope illumination and/or contrast settings and scans taken with different sample preparations.

As will be described later, prior to the slide being scanned for the first time, the slide is provided with a zero point, i.e., (0, 0), for its coordinate system. This zero point is placed on the slide as a fiducial, typically in the form of an ink dot. All subsequent scans of the tissue sample are referenced from this zero point. Further, if the slide is removed for further preparations, the coordinate system for the new position of the slide is calibrated to the original zero point so that subsequent scans can be positionally correlated with the previous scans. Additionally, if the slide is moved to another microscope for acquiring specific scans, the microscope is first checked for calibration differences. The slide is then placed on the microscope and aligned with the microscope using the previously marked zero point on the slide. As the slide is maintained at the proper alignment for each scan, different scans for the same position on the slide can be positionally correlated with one another, such that the user may evaluate the various scans taken at a selected position of interest on the slide.

The multiview virtual slide viewer can also be used to show views of additional scans which are positionally unrelated to the displayed initial scan, but are related in a sense of complementary information display, such as for example views of scans out of a reference database or a histology or cytology image atlas.

As stated, each scan is stored in one or more separate files in the database. A descriptive header file is included in the data set. The header includes the zero origin coordinate information for the slide. Furthermore it contains resolution information of the scans i.e. the distance between two image pixels in x and y direction expressed in microns. It also includes an array indicating various x, y coordinates in the slide. For each position, there are listed pointers or file names to the scans taken at these positions. Each scan file also includes a header describing the size of the scan in pixels. It may also include text information related to the scan, such as scanner hardware information, scanning date, preparation used for the scan, etc.

In addition to the database, the multi-view virtual slide viewer of the present invention further includes a computing system with a display. The computing system is connected either physically to the database or remotely via an Intranet, Internet, or other connection. The computing system of the present invention controls the display such that multiple views of the sample can be displayed simultaneously. Specifically, during an analysis session, the computing system first retrieves the data for a low-resolution scan display and presents this on the screen. The computing system further provides a position indicator, such as an arrow, window box, etc., superimposed over the low-resolution scan. This position indicator can be manipulated by the user of the computing system to select different areas of interest on the slide.

Importantly, the computing system is also capable of displaying various additional windows on the terminal. Some of the windows are used to display selected scans chosen by the user. One of the windows is a text window. This window may include information associated with each scan selected for viewing by the user. The text window may also allow the user to enter and store notes associated with a scan. These annotations can be associated with a complete scan or with individual selected locations within a scan. Additionally, the computing system allows the user to toggle between the various scans for the chosen area if desired.

The computing system is also capable of displaying a single full window view of a particular scan. Specifically, the user may select to view a scan full screen. In this instance, the computing system will hide the low-resolution scan and text window and will display the selected screen full screen. A navigation guide, such as keyboard shortcuts or pointers, is made available to the user to navigate within the scan.

The computing system of the present invention is also capable of superimposing the images of slides over each other such that the user may view corresponding pixels from all stored scans for a selected area. Specifically, in some instances, the user may wish to view one scan but be able to click on an area of the scan and see views of the same area from other scans. For example, the user may wish to view the bright field scan and select areas of the scan and see the corresponding dark field pixels for the selected area. As another example, the user could view a scan of one magnification and by selecting a particular area of the scan see pixels of a higher magnification scan for the selected area. This would be similar to placing a magnifying glass over one section of the scan.

In these embodiments, the computing system of the present invention first displays a scan selected by the user. The computing system provides selection tools, such as a pointer, window box, etc. that allow the user to select a portion of the scan. For the selected portion of the scan, the computing system provides information to the user about what other scans are available in a pop-up box. When the user selects another scan for viewing in the defined area, the computing system uses the coordinates of the selection made by the user, retrieves the data related to these coordinates from the scan file associated with the scan selected by the user, and replaces the current data displayed within the box with the data from the selected scan. For example, if a bright field scan of one magnification is currently displayed and the user selects an area of the corresponding dark field scan, the computing system will retrieve data from the scan file associated with the dark field scan and will replace the data in the window selected by the user with the dark field scan data, thereby providing the user with a complementary view with new information of the same scan in the selected area.

Generally, a data set for a tissue sample will include a large amount of data representing different scans using different lighting and contrast settings, magnification, and sample preparations. However, during analysis of the data, the user may determine that only a subset of the different scans is needed to report on their analysis of the sample. For this reason, the computing system of the present invention allows the user to save individual views of the sample in a snap shot gallery. Specifically, in one embodiment of the present invention, the user may indicate that they wish to save a particular scan. In this instance, the computing system of the present invention saves the scan in a separate file or creates a link to the file in the main header. The computing system may also associate a thumbnail of the scan on the viewing screen so that the user can more easily recall the scan.

The computing system of the present invention may also allow the user to annotate a scan with particular notes or information. The annotations can be in text form or they may be graphic information, such as lines, circles, etc., that hi-light parts of the scan.

The computing system also allows the user to perform certain measurements. These could be measurements related to the geometrical dimensions of the section or parts of the section, features describing the morphology and neighborhood relationships of cells within the tissue, single cell features, measurements such as the amount of dye absorbed by a cell, combined measurements of the same objects or areas in different scans of the same slide, etc.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an illustration of a display from a monitor illustrating operation of a conventional virtual slide viewer.

FIG. 2A is an illustration of a basic microscope set up for bright field and fluorescent microscopy.

FIG. 2B is an illustration of a basic microscope set up for dark field and bright field illumination.

FIG. 2C is an illustration of the correlation of positions on a slide when moved to different stands according to one embodiment of the present invention.

FIG. 3 is schematic block diagram of the virtual slide viewing system according to one embodiment of the present invention.

FIG. 4A is an illustration of data displayed by the virtual slide viewing system of the present invention illustrating display of multiple scans for a selected area according to one embodiment of the present invention.

FIG. 4B is an illustration of data displayed by the virtual slide viewing system of the present invention illustrating display of a full screen view of a scan of interest according to one embodiment of the present invention.

FIG. 4C is an illustration of data displayed by the virtual slide viewing system of the present invention illustrating pixels from one scan superimposed on a first scan according to one embodiment of the present invention.

FIG. 4D is an illustration of data displayed by the virtual slide viewing system of the present invention illustrating pixels from one scan superimposed on a first scan according to another embodiment of the present invention.

FIG. 4E is an illustration of data displayed by the virtual slide viewing system of the present invention illustrating storing of scans of interest in a thumbnail gallery.

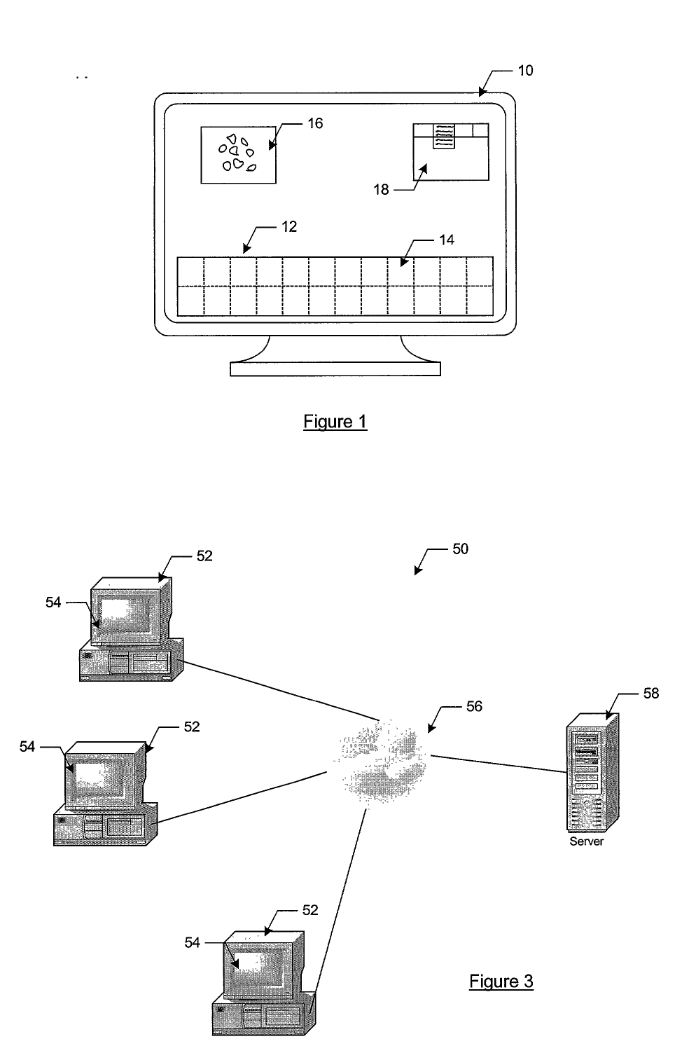

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As discussed above, an important limitation of most conventional virtual slide viewers is that they only display different bright field magnifications of a sample. They do not display scans of the sample made with different contrast and illumination settings and methods or scans of the slide taken with different preparations or scan platforms. As such, the user of a conventional virtual slide viewer receives only limited information from these systems.

For the slide viewer to be able to display multiple views of different scans of the same slide two conditions are necessary: a) the scans have to be performed in a correlated way and b) the data have to be stored in a special data structure which allows the retrieval of related data from different scans. Concerning the acquisition of images from correlated scans several situations have to be distinguished:

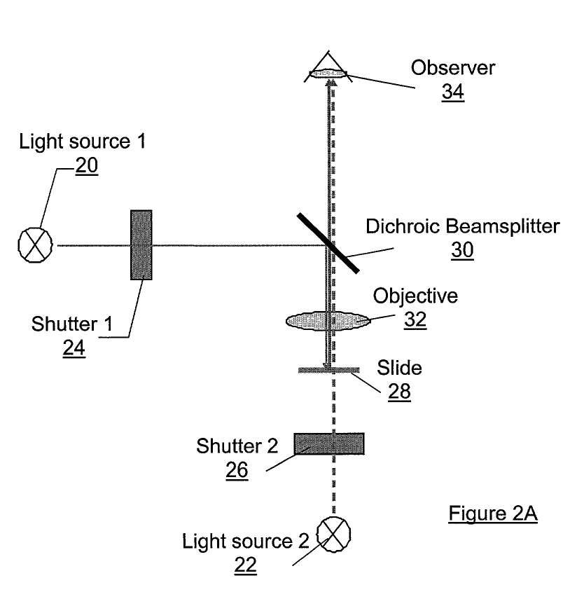

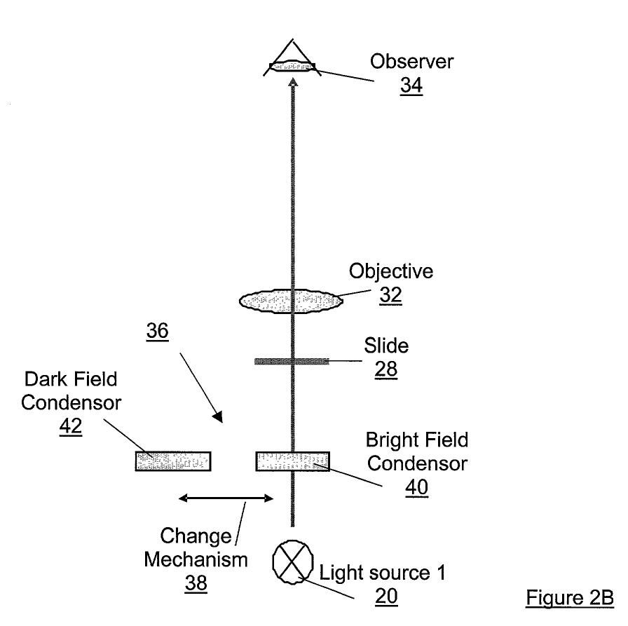

a) Multiple scans are acquired by switching the microscope settings per field of view. This means that a scan platform is provided, where the system acquires not only one bright field image per field of view but additional multiple other images with complementary features by automatically switching the microscope and/or camera parameters. Examples can be an automatic scan microscope that is set up as a bright field and a fluorescence microscope as referenced in FIG. 2A. As illustrated in this Figure, the microscope includes first and second light sources, 20 and 22, and first and second shutters, 24 and 26. The first light source is positioned to provide light to the slide 28 via a dichroic beamsplitter 30 when the first shutter is opened. The second light source 22 provides a back light source to the slide when the second shutter 26 is open. The slide is viewed through the objective 32 by an observer 34. Importantly, by closing the first shutter 24 and opening the second shutter 26, a bright field image is taken of the field of view. Further, by opening the first shutter 24 and closing the second shutter 26 enables the system to take the fluorescent image of the same field of view. An example for a bright field/fluorescence microscope as described in FIG. 2A is the Axioskop 2 Mot from Zeiss with two (2) additional integrated automatic shutters. A second example is shown in FIG. 2B and is the same device with an integrated automatic dark field condenser 36 having a change mechanism 38, which can be automatically switched between a bright field condenser 40 and the dark field condenser 42. A third example can be an integrated automated interferometer, such as for example, the Spectracube system from Applied Spectral Imaging, which allows the acquisition of multiple images with very narrow bandwidth spectral characteristics of the same field of view. Only when all these different images are taken does the system move to the next field of view and the process is repeated.

For the presentation in the multi-view virtual slide viewer, one way of stitching these images together to seamless virtual slides with a one-to-one pixel relation between the different views could be the use of the tiling parameters derived from the bright field scan. This is especially important as the precise tiling normally depends on the correlation between the overlap of adjacent images. As there is usually very little information in images derived from dark field or fluorescent settings, (most of the images is just black), correlation between adjacent images would not work in these specific settings and the tiling parameters have to be gained from elsewhere such as for example the bright field scan. The disadvantage of this method is the time it will take to switch between the different microscope settings per field. Therefore this method is only feasible for low throughput scanning and for specialty high precision scans.

b) To speed up the scan process, the system completes a scan with one microscope setting and only switches to a new setting at the end of the scan to run the slide again with the new setting. This is a faster method because the switching of the microscope settings will be done only once per scan. The precision of the correlation of the different views of the scans is obviously limited by the precision of the mechanics of the scanning stage that the automated microscope is using. The mechanics will determine with what precision it is possible to go back to the same starting point of the first scan. To increase the precision of the correlation between the first and the second scan (and following scans), a compromise can be applied: bright field images can be taken in addition to the images taken with microscope settings of the second scan at the starting point and in predefined intervals during the scan by switching the microscope settings, and the difference versus the first bright field scan and these newly acquired bright field images can be determined via correlation. This information is then used to either adjust the scan parameters of the current scan or to correct the tiling of the scan images for the display in the multi-view virtual slide viewer. In most cases the tiling parameters for the second and all following scans will be derived from the bright field scan.

c) Scans are taken from slides which, between the different scans, are removed from the platform or change the platform. Examples are slides which are scanned with one preparation, destained, restained and scanned with the new preparation again; or consecutive histological sections, where section one is prepared in one way and section two in a different way; or slides which went through a fast cost effective low resolution pre scan, for example on a flat bed scanner, for a first investigation and where a high resolution scan is ordered as a consequence of the first investigation later on, the high resolution scan being run on a different platform.

In order to relate the different views of scans taken on different platforms or after removing and reinserting the slide on the same platform, the slides have to be marked with at least two (2) fiducials in diagonally opposing comers of the slide, for example upper left and lower right comer. As one embodiment, the fiducials can be inserted using an ink dotter. From the number of pixels in the x and y direction between the two fiducials, determined in the images of the two (2) different scans the ratios nx and ny of the dimensions in x-and y-direction can be computed as referenced in FIG. 2C:

Δx₂/Δx₁=nₓ

Δy₂/Δy₁=n_{y}

Once this ratio is known an area of interest selected in the display of scan 1 in the multi-view virtual slide viewer can be related to the corresponding area in scan 2:

Area of interest selected in scan 1 with upper left coordinates (x₁,y₁) and dimensions a1 and b1 relates to the corresponding area of interest in scan 2

| | | |
|---|---|---|
| with the coordinates | x2 = x1 * nₓ | y2 = y1 * n_{y} |
| and dimensions | a2 = a1 * nₓ | b2 = b1 * n_{y} |

The coordinates are preferably related to one of the fiducial locations as zero point, as it cannot be guaranteed that some of the devices used for the scans will not truncate the left or the right end of the slide.

As mentioned previously, conventional virtual slide viewer devices only display bright field scans of varying magnifications, and do not provide scans of the sample taken with different microscope illumination and contrast settings or with different preparations. The multi-view virtual slide viewer of the present invention, on the other hand, remedies this problem. By being able to positionally correlate scans taken by different scanning devices, different microscope and/or camera settings or after different preparations have been applied to the sample, the virtual slide viewer of the present invention can provide more information to the user in analyzing the slide. Further, because not all scans have to be taken with the same device, the present invention can use a flat bed scanner to take the low magnification scan of the slide and other scanners for higher magnification scans. This, in turn, allows the virtual slide viewer of the present invention to provide a unitary low magnification scan to the user, as opposed to a tiled view.

The separation into a low resolution scan being done on one device and the high resolution scan being acquired on an other device at a later time may have several advantages. For example, the more expensive high-resolution scan may only be ordered if the investigation of the low-resolution scan indicates the need for it, i.e. scanning of TMAs. Further, the low resolution scan may be used in an interactive labeling station to mark areas of interest which later can be relocated in the high resolution virtual slide image, which was acquired by an automatic scanning platform at an earlier time, for further investigation. In that case, the operator of the interactive labeling station would not be hampered with the long processing times needed to scan a complete slide at high resolution. The same is true for the much smaller amount of data the interactive system has to deal with in comparison to the high-resolution virtual slide. Because the prior art systems cannot switch between different scanners, it must use the same scanner for both the low-resolution and hi-resolution scans. Because these scanners cannot take one continuous low-resolution scan, the prior art systems are forced to take incremental scans and tile these together to display an entire low-resolution scan of the slide.

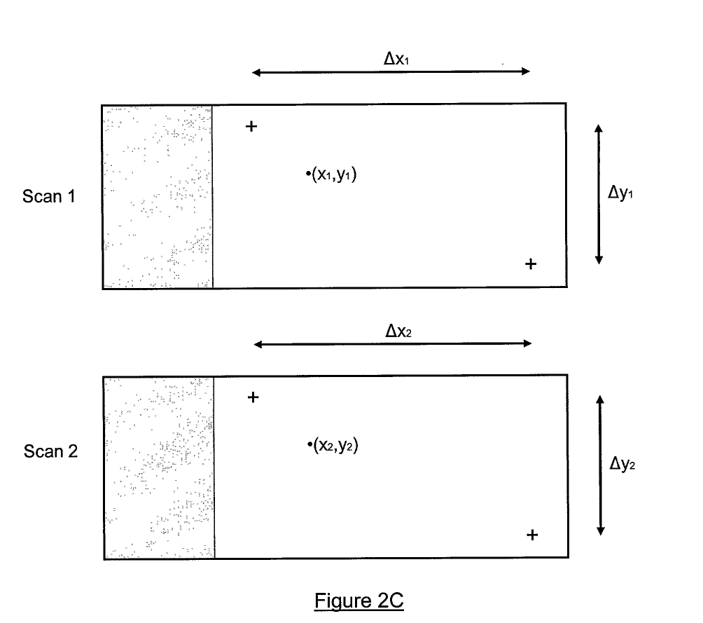

With reference to FIG. 3, a generalized view of the multi-view virtual slide viewer of the present invention is illustrated. Specifically, FIG. 3 illustrates an embodiment of the present invention in a networked system. It must be understood that the entire system could be located and ran on a general computer. However, networked systems are typically used so that files can be accessed from a remote location. Specifically, the slide viewer 50 according to one embodiment of the present invention includes one or several computing systems 52 each containing general processors. The computing systems importantly include display monitors 54. Each computing system is connected to a network 56, which could be an Intranet, Internet, or other network connection. Also located on the network is a file server 58. In operation, the files representing the various scans of a tissue sample are stored on the file server. These files are then accessed by one of the computing systems 52 via the network 56.

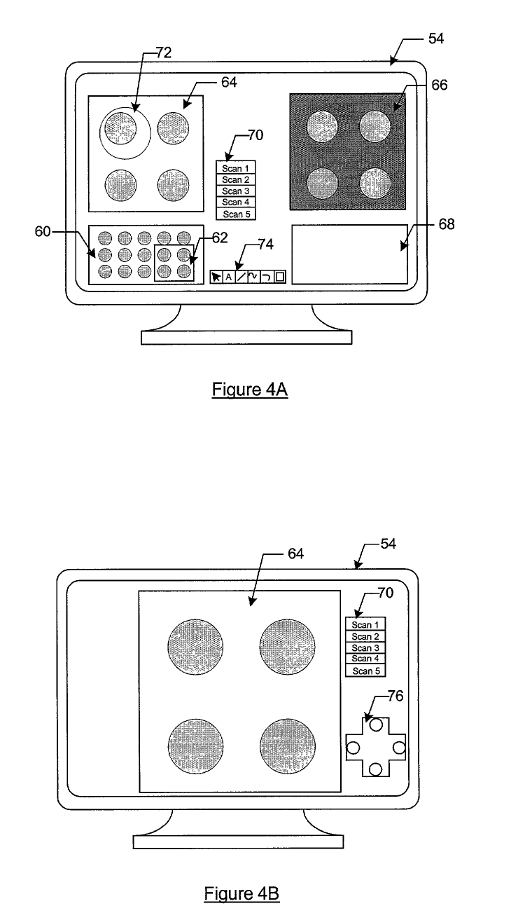

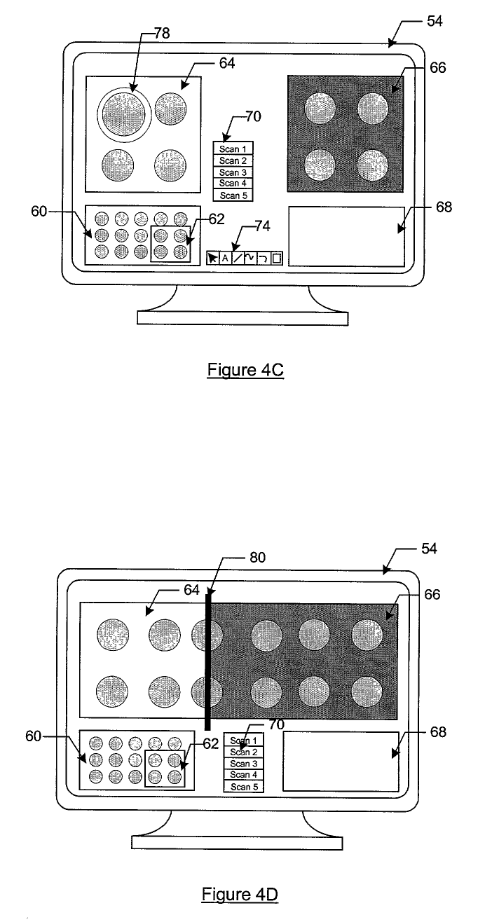

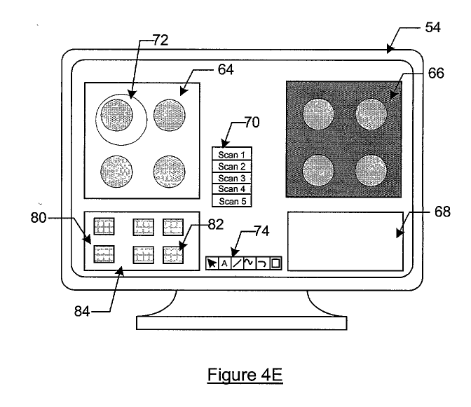

With reference to FIG. 4A, a general view of the display provided to the user of the present invention is illustrated. Specifically, during typical use, the slide viewer of the present invention provides a low-magnification scan 60 of either all or portions of a slide. This low-magnification scan is used as a visual and navigational aid to the user. Specifically, superimposed on the low-magnification scan is a navigational guide such as a moveable window 62, pointer, etc. The display also includes either one or several windows, 64 and 66. These windows are used to display various scans of the slide. These scans may be either scans at various magnifications, or scans made using different microscope illumination and contrast settings, or scans of the sample using different preparations. The scans displayed in these windows correlate to the position of the navigation guide 62 on the low-magnification scan. Thus, by moving the navigation guide about the low-magnification scan, the user can view the various saved scans for various locations on the slide. An additional window 68 may also be used to display text data concerning each scan. The user can also use this window to add text concerning a scan. Further, the multi-view slide viewer system of the present invention includes tools 74 allowing the user to draw graphic information on the scans to highlight areas of interest on the slide.

An important part of the present invention is the creation and mapping of the various scans taken of the slide. Specifically, it is important that each of the scans are properly recorded in terms of the position they were taken on the slide, so that when a user selects an area of interest on the slide, the scans for that area can be retrieved and displayed to the user. In light of this, the present invention first includes a header file in the data set of scans. This header file contains the zero origin, (i.e., 0, 0) of the coordinate system for the low-magnification scan. It further includes an array containing the location of pixels in the low-magnification scan. Importantly, the header includes a pointer or call out of the file name containing the actual data for low-magnification scan. Further, in the array, under each pixel location is listed the file names of the scans that were taken at these pixel positions, such that by selecting a pixel location in the low magnification scan, all of the scan files related to this pixel location can be accessed.

In addition to the header, the data set further includes the individual scan files for the slide. Each of the scan files also includes a local header followed by the actual scan data. The local header includes such information as the size of the file and the location on the slide where the scan was performed. Further, the header may include any text or graphical data entered at the time the scan was taken. In this manner, the overall header includes the origin and size of the overall slide with callouts or pointers to each scan and the corresponding location of the scan on the slide and each scan includes the actual data and text and graphical information concerning the individual scan.

With reference to FIG. 3, during an analysis session, the user will initially access either the local storage device on the computing system 52 or access the file server 58 via the network 56. In the case of a networked system, the computing system initially sends information concerning its display size and other compatibility information to the server. The server, in turn, formats the data of the scan so that it can be properly displayed by the client computing system. The computing system 52 accesses the main file header for the data set and with reference to FIG. 4A, displays the low magnification scan in a window 60. Additionally, a window or other navigation device 62 is superimposed over the low magnification scan.

With reference to FIG. 4A, to view scans for a particular position on the slide, the user moves the window 62 to the desired area using either a mouse or keyboard controls. The computing system notes the x, y coordinates of the area chosen by the user and accesses the main header file. The computing system accesses the array and determines the scans associated with the coordinate location chosen by the user. The names of these various scans are then provided in a pop-up selection box 70 to the user. As illustrated in FIG. 4A, based on the user's selection from this pop-up box, the computing system will access the data for the selected scan and display it in one of the windows, 64 and 66. Further, the computing system will access the header associated with the data and will display any text associated with the scan in the text window 68, such as scanner hardware information, scanning date, preparation used for the scan, etc. Further, if there is any graphical data, such as arrows, circles, pointers, etc., the computing system retrieves this data and displays it over the scan. For example, FIG. 4A illustrates a circle 72 that has been drawn around an area of interest in the scan.

Using the pop-up table, the user may select another scan to be displayed in the next window 66. Further, the user may toggle between different scans. Additionally, the user may enter text information using the text window 68 to be saved with the scan. The computing system may also include a graphic toolbar 74 that allows the user to draw and save graphic images, such as circles, pointers, etc., on the scan.

Importantly, as earlier noted, the multi-view virtual scan viewer of the present invention allows the user access not only to scans representing different magnifications, but also to various other scans associated with the sample. Specifically, the multi-view virtual slide viewer of the present invention provides scans taken with different microscope illumination and contrast settings, different magnifications, and with different slide preparations. As such, all scanned information related to the sample is provided to the user for analysis. In addition digitally created new views of acquired scans can be computed and presented in the multi-view virtual slide viewer. Such views for example may display just one marker digitally extracted via Chromagen Separation from the RGB image of a multi marker scan. It may display just the counter stain part of the scanned slide. It may present special features extracted from the original scan image and translated into a false color presentation based on selected feature distributions and look-up tables. The multiview virtual slide viewer can also be used to show views of additional scans which are positionally unrelated to the displayed initial scan, but are related in a sense of complementary information display, such as for example views of scans out of a reference database or a histology or cytology image atlas. These are only some examples of many possible embodiments. Because the user can view the various scans simultaneously for a selected area and can toggle between scans, the user can perform a more complete analysis of the slide.

In addition to providing a display having multiple windows for simultaneously display of several slides, the multi-view virtual slide viewer of the present invention also provides additional features. For example, with reference to FIG. 4B, the multi-view virtual slide viewer of the present invention may provide a full screen view of a scan of interest. In this embodiment, to make maximum slide information available to the user, the window 64 containing the scan is maximized and the remaining windows are hidden. The multi-view virtual slide viewer of the present invention may further provide keyboard shortcuts to allow the viewer to navigate within the scan. Further, the multi-view slide viewer may include navigational guides such as directional arrows 76 that may be clicked with a mouse to navigate within the scan. Further, the multi-view slide viewer may display the pop-up selection box 70 allowing the user to select or toggle to other scans.

FIGS. 4C and 4D illustrate another important aspect of the present invention. Specifically, the multi-view virtual slide viewer of the present invention is capable of superimposing the scanned pixels from one scan onto the pixels of another scan. This, in turn, allows the user to view one scan and toggle certain portions of the scan to see different scan views for a selected area of the scan. A classic example of this aspect of the present invention is to provide a virtual magnifying glass for the user. Specifically, with reference to FIG. 4C, the user could display a scan 64 having a lower magnification. Using a selector 78, such as a window or other device, the user could select an area of the scan for further magnification. Using the coordinates of the selected area, the virtual slide viewer will access a corresponding scan for the selected area and retrieve pixel data from the scan file corresponding a scan taken at higher magnification for the pixel location. These magnified pixel data is then superimposed over the lower magnification pixels within the selected window 78 to thereby provide a magnified view. This same concept would hold true for other types of scans. For example, the user may display a bright field scan and choose within the bright field scan to view corresponding dark field scan data, fluorescent data, spectral data, data derived from chromagen separation, etc.

FIG. 4D illustrates a similar concept, except that in this embodiment a slide bar 80 is used. One scan is displayed to the left of the slide bar and a different scan is displayed to the right of the slide bar. In this case, a bright field scan is illustrated on the left and a dark field scan is located on the right. The slide bar represents the transition from one set of scan data to the other. By moving the slide bar horizontally, the user can change the data display. Specifically, if the slide bar is moved left, the bright field scan pixels previously located on the left of the slide bar that are now on the right are superimposed by the virtual slide viewer with the corresponding pixels from the dark field scan. It is understood that this concept of the invention applies to all the different views. For example, each side may be different magnifications, with the slide bar changing magnification as it is slid left or right. It may be used to view bright field data versus fluorescent data, different spectral data, different data derived from chromagen separation, etc.

Depending on the analysis to be performed on the sample, there may be several scans, which the user will view during analysis. However, there may be a subset of these scans that the user determines to be important for analysis and also for generation of a report concerning the sample. In light of this, the virtual slide viewer of the present invention further allows the user to take snap shots of the scans. Specifically, while viewing the scans the user may flag particular scans of interest. In this instance, the parameters of the flagged scan such as location, magnification, size and type of scan (bright field, dark field, etc.) are stored in the database, along with date, time and user identification. In addition, the user may add textual comment to the snapshots. These comments are also stored with date, time and user identification. Depending on the configuration of the system, the user may select to display her/his own snapshots only or the snapshots of all users. Further, as illustrated in FIG. 4E, the saved scan may appear as a thumbnail 82 in a snap shot gallery 84 displayed on the monitor. This gallery may replace the low magnification map image 60. The user can review these saved images by clicking on the thumbnail. These saved scans can also be used to generate reports concerning the analysis of the tissue.

The computing system of the present invention also allows the user to perform measurements. These could be measurements of large structural compounds of the slide, such as the dimensions of whole glands, tissue layers, large cell clusters etc., or of smaller compounds such as individual cells. The measurements can be related to individual cell features, such as the cell morphology, texture, amount of dye absorbed by the cells, or of more global features such as the neighborhood relationships between cells in a tissue section, etc. In addition features can be extracted from multiple views of the same scan to create a feature set with a maximum of information. Features extracted from the scans can be presented and displayed in a graphical way as a new view of the scan in the multi-view virtual slide viewer.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A slide viewer capable of simultaneous display of more than one scan of an area of interest of a slide, said viewer comprising:
a database containing at least two data files representing different scans for a same area of interest on a slide, wherein the scans are of views that are at least one of a different illumination and a different contrast;
a processor associated with said database; and
an interface associated with said processor for display of the different scans,
wherein said processor retrieves said data files representing different scans of the same area of interest and displays these scans on said interface, such that a user may simultaneously view scans of the same area of interest that are of views different from each other by at least one of illumination and contrast.

2. A slide viewer according to claim 1, wherein said processor further displays a low-magnification scan of the slide on said interface, wherein the low-magnification scan has an associated coordinate map that defines the different coordinate positions of the low-magnification scan.

3. A slide viewer according to claim 2, wherein said processor further displays a navigation guide superimposed over the low-magnification scan and displays on said interface a list of the scans stored in the database that correspond to a coordinate location where the navigation guide is currently located on the low-magnification scan.

4. A slide viewer according to claim 3, wherein said interface allows a user to move the navigation guide to different coordinate locations on the displayed low-magnification scan, displays a list of scans stored in the database that correspond to the current coordinate location of the navigation guide on the low-magnification scan, and allows a user to select from the listed scans associated with the slide at the current location of the navigation guide.

5. A slide viewer according to claim 3, wherein said database further includes a header file that includes the various x, y coordinates of the low-magnification scan and a list of data files representing scans associated with each x, y coordinate on the low-magnification scan, wherein when the navigation guide is placed over a selected x, y coordinate on the low-magnification scan, said processor accesses the header and displays in a table on said interface the scans associated with the selected x, y coordinates.

6. A slide viewer according to claim 2, wherein the low-magnification scan is created using a flat bed scanner, such that the entire low-magnification scan is one data file, and wherein said processor displays the low-magnification scan on said interface as a unitary scan.

7. A slide viewer according to claim 1, wherein said database further includes data files containing scans taken at different magnifications for a same area of interest on a slide, and wherein said processor is capable of simultaneously displaying scans that differ in magnification, illumination, and contrast on said interface for the same area of interest on the slide, such that a user may simultaneously view scans of the same area of interest that are different from each other by at least one of magnification, illumination, digital information presentation, and contrast.

8. A slide viewer according to claim 1, wherein said at least two data files represent scans taken with different scanning devices, wherein the data files are related to each other by a common coordinate system, such that the scans can be correlated with the same area of interest on the slide when displayed by said processor.

9. A slide viewer according to claim 1, wherein at least one of the data files further includes text information associated with the scan stored in the data file, and wherein said processor accesses the data file and displays the text information in a text box on said interface.

10. A slide viewer according to claim 9, wherein said processor is capable of receiving input text information from a user and displaying the text in the text box, and wherein said processor is further capable of storing the text input by the user in the data file associated with the scan.

11. A slide viewer according to claim 1, wherein at least one of said data files further includes graphic information associated with the scan stored in the data file, and wherein said processor displays on said interface the scan stored in the data file and the graphic information stored in the data file.

12. A slide viewer according to claim 1, wherein said processor displays a full screen view of a selected scan on said interface such that the selected scan substantially fills the display.

13. A slide viewer according to claim 12, wherein said processor displays a navigational guide to the user, wherein said processor is capable of receiving inputs from the user based on user's interaction with the navigational guide and manipulating the display of the full screen scan based on the user inputs.

14. A slide viewer according to claim 1, wherein said processor displays a first scan on said interface of an area of interest, wherein said processor displays on said interface a selector window for use by a user to select regions on the displayed first scan, and wherein within a region selected by the user defined by said selector window, said processor displays pixel data from a second scan of the area of interest such that data from the first scan is displayed outside of the selector window and data from the second scan is displayed inside the selector window.

15. A slide viewer according to claim 1, wherein said processor displays a reference line on said interface and on one side of the reference line said processor displays data from a first scan and one an opposite side of said reference line, said processor displays data from a second slide.

16. A slide viewer according to claim 15, wherein said processor is responsive to user input to move the reference line on said interface, and wherein said processor updates the display of the first and second scans, such that a region of the first scan now located on the opposed side of the reference line is replaced with corresponding data from the second scan.

17. A slide viewer according to claim 1, wherein said processor displays a tool bar on said interface containing graphic functions, and wherein said processor is responsive to input from a user to display graphical images on said interface using the graphical functions.

18. A slide viewer according to claim 1, wherein said processor, responsive to user input, stores in a separate file information related to scans selected by the user, and wherein said processor further displays thumbnail versions of the selected files on said interface.

19. A slide viewer capable of simultaneous display of more than one scan of an area of interest of a slide, said viewer comprising:
a database containing at least two data files representing different scans for a same area of interest on a slide, wherein the scans are of views of different digital representations;
a processor associated with said database; and
an interface associated with said processor for display of the different scans,
wherein said processor retrieves said data files representing different scans of the same area of interest and displays these scans on said interface, such that a user may simultaneously view different scans of the same area of interest.

20. A slide viewer capable of simultaneous display of more than one scan of an area of interest of a slide, said viewer comprising:
a database containing at least two data files representing different scans for a same area of interest on a slide;
a processor associated with said database; and
an interface associated with said processor for display of the different scans,
wherein said processor displays a first scan on said interface of an area of interest, wherein said processor displays on said interface a selector window for use by a user to select regions on the displayed first scan, and wherein within a region selected by the user defined by said selector window, said processor displays pixel data from a second scan of the area of interest such that data from the first scan is displayed outside of the selector window and data from the second scan is displayed inside the selector window.

21. A slide viewer capable of simultaneous display of more than one scan of an area of interest of a slide, said viewer comprising:
a database containing at least two data files representing different scans for a same area of interest on a slide;
a processor associated with said database; and
an interface associated with said processor for display of the different scans,
wherein said processor displays a reference line on said interface and on one side of the reference line said processor displays data from a first scan and one an opposite side of said reference line, said processor displays data from a second slide, and
wherein said processor is responsive to user input to move the reference line on said interface, and wherein said processor updates the display of the first and second scans, such that a region of the first scan now located on the opposed side of the reference line is replaced with corresponding data from the second scan.

22. A slide viewer capable of simultaneous display of more than one scan of an area of interest of more than one slide, said viewer comprising:
a database containing at least two data files representing scans for the same area of interest on at least two different slides, wherein the slides contain correlated information;
a processor associated with said database; and
an interface associated with said processor for display of the different scans,
wherein said processor retrieves said data files representing scans of the same area of interest on different slides with correlated information and displays these scans on said interface, such that a user may simultaneously view scans of the same area of interest from at least two different slides with correlated information.

23. A method for simultaneously displaying more than one scan of an area of interest of a slide, said method comprising the steps of:
storing in a database at least two data files representing different scans for a same area of interest on a slide, wherein the scans are of views that are at least one of a different illumination and a different contrast;
retrieves data files representing different scans of the same of area of interest; and
displaying these scans on an interface, such that a user may simultaneously view scans of the same area of interest that are of views different from each other by at least one of illumination and contrast.

24. A method according to claim 23, wherein said displaying step further displays a low-magnification scan of the slide on the interface, wherein the low-magnification scan has an associated coordinate map that defines the different coordinate positions of the low-magnification scan.

25. A method according to claim 24, wherein said displaying step further displays a navigation guide superimposed over the low-magnification scan and displays on the interface a list of the scans stored in the database that correspond to a coordinate location where the navigation guide is currently located on the low-magnification scan.

26. A method according to claim 25 further comprising the step of moving the navigation guide to different locations on the displayed low-magnification scan based on received input from a user, wherein said displaying step displays a list of scans stored in the database that correspond to the current coordinate location of the navigation guide on the low-magnification scan and displays scans selected by the user from the listed scans.

27. A method according to claim 25, wherein said storing step stores in the database a header file that includes the various x, y coordinates of the low-magnification scan and a list of data files representing scans associated with each x, y coordinate on the low-magnification scan, wherein when the navigation guide is placed over a selected x, y coordinate on the low-magnification scan, said displaying step accesses the header and displays in a table on the interface the scans associated with the selected x, y coordinates.

28. A method according to claim 24, wherein the low-magnification scan is created using a flat bed scanner, such that the entire low-magnification scan is one data file, and wherein said displaying step displays the low-magnification scan on the interface as a unitary scan.

29. A method according to claim 23, wherein said storing step further stores in the database data files containing scans taken at different magnifications for a same area of interest on a slide, and wherein said displaying step processor is capable of simultaneously displaying scans that differ in magnification, illumination, digital information presentation, and contrast on the interface for the same area of interest on the slide, such that a user may simultaneously view scans of the same area of interest that are different from each other by at least one of magnification, illumination, digital information presentation, and contrast.

30. A method according to claim 23, wherein the at least two data files represent scans taken with different scanning devices, wherein the data files are related to each other by a common coordinate system, such that the scans can be correlated with the same area of interest on the slide when displayed by said displaying step.

31. A method according to claim 23, wherein at least one of the data files further includes text information associated with the scan stored in the data file, and wherein said displaying step accesses the data file and displays the text information in a text box on the interface.

32. A method according to claim 31 further comprising the step of receiving input text information from a user, wherein said displaying step displays the text in the text box, and wherein said storing step stores the text input by the user in the data file associated with the scan.

33. A method according to claim 23, wherein at least one of the data files further includes graphic information associated with the scan stored in the data file, and wherein said displaying step displays on the interface the scan stored in the data file and the graphic information stored in the data file.

34. A method according to claim 23, wherein said displaying step displays a full screen view of a selected scan on the interface such that the selected scan substantially fills the display.

35. A method according to claim 34, wherein said displaying step displays a navigational guide to the user, wherein said method further comprises the steps of:
receiving inputs from the user based on user's interaction with the navigational guide, and
manipulating the display of the full screen scan based on the user inputs.

36. A method according to claim 23, wherein said displaying step displays a first scan on the interface of an area of interest and displays on the interface a selector window for use by a user to select regions on the displayed first scan, and wherein within a region selected by the user defined by the selector window, said displaying step displays pixel data from a second scan of the area of interest such that data from the first scan is displayed outside of the selector window and data from the second scan is displayed inside the selector window.

37. A method according to claim 23, wherein said displaying step displays a reference line on the interface and on one side of the reference line said displaying step displays data from a first scan and one an opposite side of the reference line, said displaying step displays data from a second slide.

38. A method according to claim 37 further comprising the step of moving the reference line on the display based on user input, and wherein said displaying step updates the display of the first and second scans, such that a region of the first scan now located on the opposed side of the reference line is replaced with corresponding data from the second scan.

39. A method according to claim 23, wherein said displaying step displays a tool bar on the interface containing graphic functions, and wherein said displaying step, responsive to input from a user, displays graphical images on the interface using the graphical functions.

40. A method according to claim 23, wherein said storing step, responsive to user input, stores in a separate file information related to scans selected by the user, and wherein said displaying step further displays thumbnail versions of the selected files on the interface.
